(19) United States
(12) Patent Application Publication
(10) Pub. No.: US 2006/0153017 A1
(43) Pub. Date: Jul. 13, 2006

(54) Method and apparatus for protecting shared data and method and apparatus for reproducing data from recording medium using local storage

(76) Inventor: Kun Suk Kim, Anyang-si (KR)

Correspondence Address: HARNESS, DICKEY & PIERCE, P.L.C., P.O. BOX 8910, RESTON, VA, 20195, US

(21) Appl. No.: 11/325,499

(22) Filed: Jan. 5, 2006

Related U.S. Application Data
(60) Provisional application No. 60/641,779, filed on Jan. 7, 2005.
(60) Provisional application No. 60/655,908, filed on Feb. 25, 2005.

(30) Foreign Application Priority Data
Dec. 7, 2005 (KR) 10-2005-0118681

(51) Int. Cl. G11B 21/08

(52) U.S. Cl. 369/30.01; 369/30.23

(57) ABSTRACT

A method and apparatus for protecting shared data and method and apparatus for reproducing data from a recording medium using a local storage are disclosed. The present invention includes downloading the shared data associated with a recording medium to a local storage and permitting an application having valid access information for the shared data to access the shared data. The present invention includes downloading encrypted shared data associated with the recording medium to the local storage, constructing a virtual package including the shared data by binding data within the local storage to data within the recording medium, decrypting the shared data using the virtual package, and reproducing the decrypted shared data. Accordingly, the contents provided by an authentic content provider and the non-transmuted contents can be reproduced, whereby the shared data can be protected. And, the shared data can be protected against a malicious function caused by an unauthorized application.

This application claims the benefit of the Korean Patent Application No. 10-2005-0118681, filed on Dec. 7, 2005, which is hereby incorporated by reference as if fully set forth herein.

This application claims the benefit of the U.S. Provisional Application No. 60/641,779, filed on Jan. 7, 2005, in the name of inventor Kun Suk KIM, entitled “METHOD FOR SECURITY AND CERTIFICATION OF DIGITAL CONTENTS”, and No. 60/655,908, filed on Feb. 25, 2005, in the name of inventor Kun Suk KIM, entitled “SECURITY AND CONTENT PROTECTION METHOD OF BLU-RAY DISC”, which are hereby incorporated by reference as if fully set forth herein.

### BACKGROUND OF THE INVENTION

1. Field of the Invention

The present invention relates to a playback of a recording medium, and more particularly, to a method and apparatus for protecting shared data and method and apparatus for reproducing data from a recording medium using a local storage.

2. Discussion of the Related Art

Generally, optical discs capable of recording large-scale data as recording media are widely used. Recently, a new high-density recording medium, e.g., Blu-ray disc (hereinafter abbreviated BD) has been developed to store video data of high image quality and audio data of high sound quality for long duration.

The BD as a next generation recording medium technology is a next generation optical record solution provided with data remarkably surpassing that of a conventional DVD. And, many efforts are made to research and develop the BD together with other digital devices.

An optical recording/reproducing device with the application of the Blu-ray Disc specifications starts to be developed. Yet, due to the incomplete Blu-ray disc specifications, the complete development of the optical recording/reproducing device has many difficulties.

Specifically, the optical recording/reproducing device should be provided with a basic function of recording and reproducing a Blu-ray disc (BD) and additional functions considering convergence with peripheral digital devices. Hence, it is expected that the optical recording/reproducing device should be provided with a general function of receiving to display an external input signal and a function of reproducing a BD together with the external input signal.

However, in reproducing the external input signal and the BD, since a preferable method of protecting shared data provided by a content provider has not been proposed or developed, many limitations are put on the development of a full-scale BD based optical recording/reproducing device.

### SUMMARY OF THE INVENTION

Accordingly, the present invention is directed to a method and apparatus for protecting shared data and method and apparatus for reproducing data from a recording medium using a local storage that substantially obviate one or more problems due to limitations and disadvantages of the related art.

An object of the present invention is to provide a method and apparatus for protecting shared data and method and apparatus for reproducing data from a recording medium using a local storage, by which the shared data provided by an authentic content provider is protected and by which the shared data is prevented from being used by an unauthorized application.

Another object of the present invention is to provide a method and apparatus for protecting shared data and method and apparatus for reproducing data from a recording medium using a local storage, by which the shared data is protected.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of protecting shared data according to the present invention includes the steps of downloading the shared data associated with a recording medium to a local storage and permitting an application having valid access information for the shared data to access the shared data.

For example, the access information is credential of the application.

For example, the credential is included in a permission request file.

For example, the permission request file exists within a JAR file configuring the application.

For example, the credential includes Grantoridentifier, Expirationdate, Filename, Signature and Certchainfileid.

For example, the method further includes the step of authenticating the shared data before the application accesses the shared data.

For example, if the shared data is shared between recording media provided by a content provider, the shared data is authenticated using a certificate of the content provider.

For example, the certificate includes a signature of the content provider.

For example, if the shared data is shared between a plurality of content providers, the shared data is authenticated using a certificate of a plurality of the content providers.

For example, the certificate includes a common signature of a plurality of the content providers.

In another aspect of the present invention, a method of reproducing a recording medium using a local storage includes the step of downloading encrypted shared data associated with the recording medium to the local storage, constructing a virtual package including the shared data by binding data within the local storage to data within the recording medium, decrypting the shared data using the virtual package, and reproducing the decrypted shared data.

For example, the shared data is reproduced by an execution of application accessing the shared data.

For example, the application includes credential of the application as access information to the shared data.

For example, the shared data is decrypted using a key included in the application.

For example, the shared data is decrypted using a key stored in the recording medium.

For example, the shared data is decrypted using a key stored in an optical player.

For example, in constructing the virtual package, the shared data is authenticated to construct the virtual package.

For example, if the shared data is shared between recording media provided by a content provider, the shared data is authenticated using a signature within a certificate of the content provider.

For example, if the shared data is shared between a plurality of content providers, the shared data is authenticated using a common signature within a certificate of a plurality of the content providers.

For example, if the shared data is shared between recording media provided by a content provider, the shared data is authenticated using a key for the content provider.

For example, if the shared data is shared between a plurality of content providers, the shared data is authenticated using a key in accordance with a plurality of the content providers.

In another aspect of the present invention, an apparatus for protecting shared data includes a local storage storing downloaded shared data associated with a recording medium and a controller controlling an application having valid access information for the shared data to access the shared data.

For example, the access information is credential of the application.

preferably, the credential is included in a permission request file.

preferably, the permission request file exists within a JAR file configuring the application.

preferably, the controller authenticates the shared data before the application accesses the shared data.

preferably, if the shared data is shared between recording media provided by a content provider, the shared data is authenticated using a certificate of the content provider.

preferably, if the shared data is shared between a plurality of content providers, the shared data is authenticated using a certificate of a plurality of the content providers.

In a further aspect of the present invention, an apparatus for reproducing a recording medium using a local storage includes a local storage storing a downloaded encrypted shared data associated with the recording medium, and a controller constructing a virtual package including the shared data by binding data within the local storage to data within the recording medium, the controller decrypting to reproduce the shared data using the virtual package.

Preferably, in decrypting the shared data, the controller controls application having valid access information for the shared data to access the shared data.

preferably, the access information is credential of the application accessing the shared data.

preferably, in constructing the virtual package, the controller authenticated the shared data to construct the virtual package.

preferably, if the shared data is shared between recording media provided by a content provider, the controller authenticates the shared data using a certificate of the content provider.

For example, if the shared data is shared between a plurality of content providers, the controller authenticates the shared data using a common signature within a certificate of a plurality of the content providers.

For example, if the shared data is shared between recording media provided by a content provider, the shared data is encrypted using a key for the content provider.

For example, if the shared data is shared between a plurality of content providers, the shared data is encrypted using a key in accordance with a plurality of the content providers.

For example, in decrypting the shared data, the controller decrypts the shared data using a key included in an application to access the shared data.

For example, in decrypting the shared data, the controller decrypts the shared data using a key stored in the recording medium.

For example, in decrypting the shared data, the controller decrypts the shared data using a key stored in an optical recording/reproducing device.

By the present invention, a playback system can be protected from a malicious function of an application and contents can be safely provided. Hence, the present invention provides more convenient functions to a user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exemplary diagram for explaining a unified use between an optical recording/reproducing device and peripheral devices to facilitate conceptional understanding of the present invention;

FIG. 2 is a diagram of a file structure recorded within a recording medium according to the present invention such as a BD-ROM;

FIG. 3 is a diagram of a data record structure recorded in a recording medium according to the present invention;

FIG. 4 is a block diagram of an optical recording/reproducing device according to one embodiment of the present invention;

FIG. 5 is an exemplary diagram of a file architecture within a local storage according to the present invention;

FIG. 6 is a diagram for explaining shared data authenticating process according to one embodiment of the present invention;

FIG. 7 is a diagram of a certificate chain used for data authentication according to the present invention;

FIG. 8 is a diagram of a JAR file configuring a signed application according to one embodiment of the present invention;

FIG. 9 is a flowchart of an authentication process of a file within a JAR file configuring a signed application according to one embodiment of the present invention;

FIG. 10 is a diagram of a JAR file configuring a signed application according to one embodiment of the present invention;

FIG. 11 is a flowchart of shared data reproducing method according to one embodiment of the present invention;

FIG. 12 is a block diagram of a recording medium playback apparatus utilizing a playback system according to one embodiment of the present invention; and

FIG. 13 is an exemplary diagram for explaining shared data protection according to the present invention, in which a virtual package is shown in detail.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, for convenience of explanation, the present invention takes an optical disc, and more particularly, “Blu-ray disc (BD)” as an example of a recording medium. Yet, it is apparent that the technical idea of the present invention is identically applicable to other recording media.

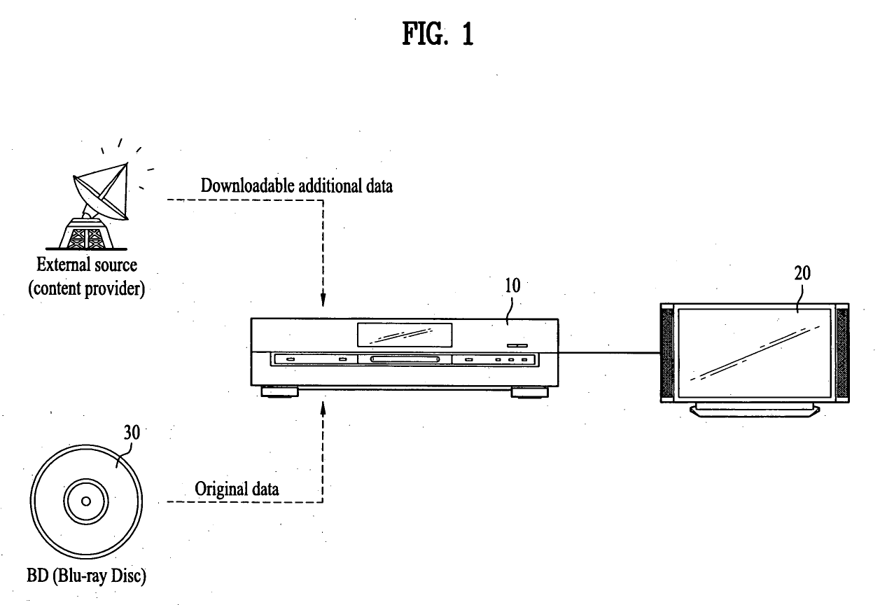

In the present invention, “local storage” is a sort of a storage means provided within an optical recording/reproducing device shown in FIG. 1 and means an element in which a user can randomly store necessary information and data to utilize. In particular, the local storage, which is currently used in general, includes “hard disc”, “system memory”, “flash memory” or the like, which does not put limitation on the scope of the present invention.

Specifically, the “local storage” is utilized as a means for storing data associated with a recording medium (e.g., Blu-ray disc). The data associated with the recording medium to be stored within the local storage generally includes data downloaded from outside.

Besides, it is apparent that a permitted data directly read out of a recording medium in part or a generated system data (e.g., metadata, etc.) associated with recording/reproduction operations of the recording medium can be stored within the local storage.

For convenience of explanation of the present invention, the data recorded within the recording medium shall be named “original data” and the data associated with the recording medium among the data stored within the local storage shall be named “additional data”.

In the present invention, “title” is a reproduction unit configuring an interface with a user. Each title is linked to a specific object file. And, a stream associated with the corresponding title recorded within a disc is reproduced according to a command or program within the Object file. In particular, for explanation convenience of the present invention, a title having moving picture, movie and interactive information according to MPEG2 compression among titles recorded within a disc shall be named “HDMV Title”. And, a title having moving picture, movie and interactive information executed by a Java program among titles recorded within a disc shall be named “BD-J Title”.

In the present invention, the title also means an indexing item existing in an index table. Namely, “First Playback”, which has information of an initially reproduced image once a recording medium is loaded, or “Top Menu”, which provides a menu image is a sort of the title. Namely, a reproduction unit configuring an interface with a user corresponds to a title of the present invention regardless of its name.

And, the title is characterized in being configured with data within a recording medium and/or a local storage. The data within the local storage can include data that is downloaded while the title is being reproduced.

FIG. 1 is an exemplary diagram for explaining a unified use between an optical recording/reproducing device 10 and peripheral devices to facilitate conceptional understanding of the present invention.

Referring to FIG. 1, “optical recording/reproducing device” 10 according to the present invention enables a record or playback of an optical disc according to versatile specifications. And, the optical recording/reproducing device 10 can be designed to record/play an optical disc (e.g., BD) of a specific specification. Moreover, the optical recording/reproducing device 10 can be made to play an optical disc. In the following description of the present invention, by considering interactivity between a Blu-ray disc (BD) and a peripheral device, a BD-player or a BD-recorder will be taken as an example. And, it is apparent that the “optical recording/reproducing device” 10 includes “drive” loadable within a computer or the like.

The optical recording/reproducing device 10 according to the present invention is equipped with a function of recording/playing an optical disc 30 and a function of receiving an external input signal, performing signal-processing on the received signal, and delivering a corresponding image to a user via another external display 20. In this case, no limitation is put on the external input signal. And, a DMB (digital multimedia broadcast) signal, an Internet signal or the like can be a representative one of the external input signals. In case of Internet as an easily accessible medium, a specific data on Internet can be downloaded via the optical recording/reproducing device 10 to be utilized.

Besides, a party, who provides contents, as an external source is generically named “content provider (CP)”.

In the present invention, contents, which configure a title, mean data provided by a recording medium author.

Specifically, the object of the present invention is to protect the contents provided by the content provider and to protect a user's playback system.

The original data and the additional data will be explained in detail as follows. For instance, if a multiplexed AV stream for a specific title is recorded as an original data recorded within an optical disc and if an audio stream (e.g., English) different from the audio stream (e.g., Korean) of the original data is provided as an additional data on Internet, a request for downloading the audio stream (e.g., English) as the additional data on Internet to reproduce together with the AV stream of the original data or a request for downloading the audio stream (e.g., English) as the additional data on Internet to reproduce will exist according to a user. To enable the requests, association between the original data and the additional data needs to be regulated and a systematic method of managing/reproducing the data according to the user's request is needed.

For convenience of explanation in the above description, a signal existing outside the disc is named additional data, which is identified according to a method of acquiring each data but does not put limitation on restricting the original or additional data to a specific data.

Hence, the additional data generally includes audio, presentation graphic (PG), interactive graphic (IG), text subtitle or the like, on which limitation is not put. And, the additional data can correspond to a multiplexed AV stream including all of the illustrated data and video. Namely, data having any kind of attribute, which exists outside the optical disc and is associated with the original data, can become the additional data.

Moreover, the additional data can be individually downloaded per index file (index), PlayList file (*.m2ts) or clip information file (*.clpi). Besides, the additional data can be downloaded by contents unit or by title unit.

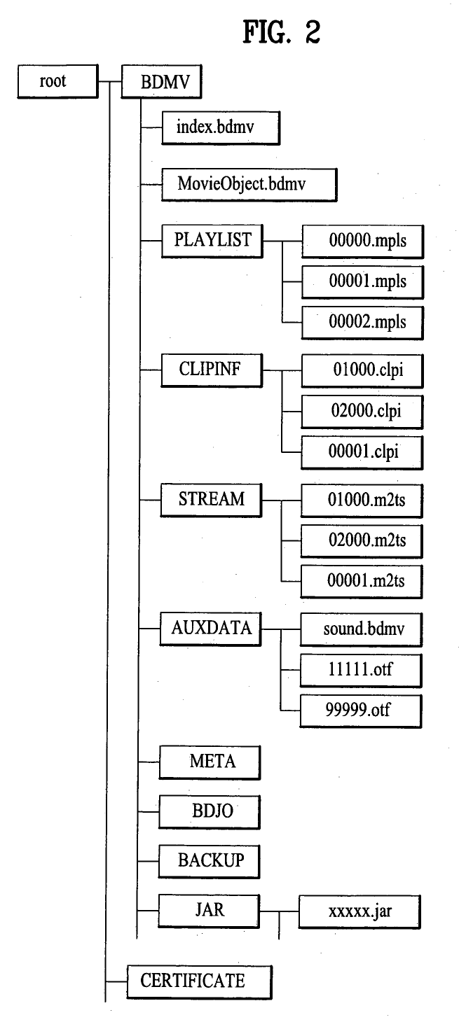

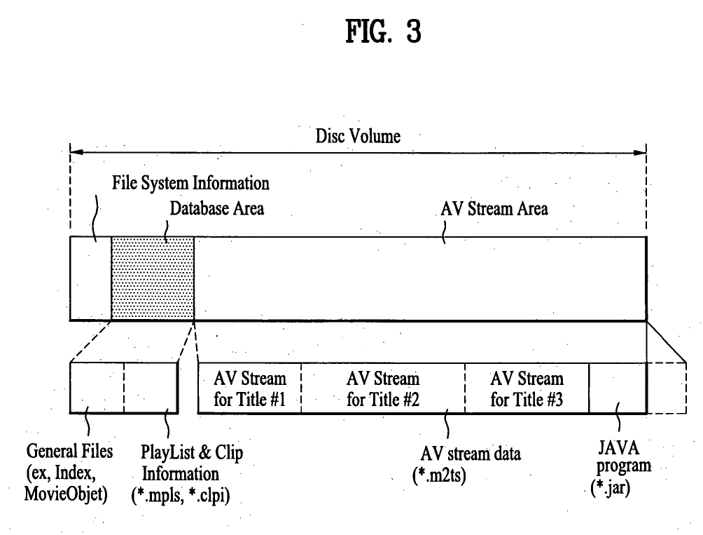

To realize the user's requests, it is essential to provide a file structure between the original data and the additional data. File and data record structures usable for a Blu-ray disc (BD) are explained in detail with reference to FIG. 2 and FIG. 3 as follows.

FIG. 2 is a diagram of a file structure recorded within a recording medium according to the present invention such as a BD-ROM.

Referring to FIG. 2, in a reproduction management file structure according to the present invention, at least one BDMV directory exists below one root directory. An index file (“index.bdmv”) and an object file (“MovieObject.bdmv”) as general file (higher file) to secure interactivity with a user exist within the BDMV directory. And, the BDMV directory, which has information of data actually recorded within a disc and information about reproducing the recorded data information, is provided with PLAYLIST directory, CLIPINF directory, STREAM directory, BDJO directory including a BD-J Object file, and JAR directory including a JAR file. And, the BDMV directory is also provided with AUXDATA directory including auxiliary data associated with disc reproduction. The directories and files included in each of the directories are explained in detail as follows.

In STREAM directory, AV stream files recorded within a disc in a specific format exist and “.m2ts” is used as an extension of a stream file (0100.m2ts, . . . ). In particular, moving picture data is generally recorded as contents associated with the present invention within the stream file.

CLIPINF directory includes clip information files (01000.clpi, . . . ) corresponding to the stream files, respectively. In particular, the clip information file (*.clpi) includes attribute information and timing information of the corresponding stream file. In particular, the clip information file (*.clpi) corresponding to the stream file (*.m2ts) by one-to-one are bound together to be named “clip”. Namely, this means that a clip information file (*.clpi) must exist for one corresponding stream file (*.m2ts).

PLAYLIST directory includes PlayList files (00000.mpls, . . . ). Each of the PlayList files (00000.mpls, . . . ) includes at least one PlayItem designating a playing time of a specific clip. The PlayItem has information about reproduction start time (IN-Time) and reproduction end time (OUT-Time) of a clip designated as a clip name (clip_Information_File_name) within a specific clip, i.e., PlayItem to be reproduced.

Namely, the PlayList file (*.mpls) becomes a basic reproduction management file unit within an entire reproduction management file structure, which performs a reproduction of a specific clip by a combination of at least one or more PlayItems.

In particular, the PlayList file (*.mpls) can be operated by a command given by a specific object file within the object file. Hence, in viewpoint of a disc playback scenario, the object file performs or manages a dynamic scenario and the PlayList file (*.mpls) performs or manages a static scenario.

BDJO directory includes a BD-J Object file for reproducing a BD-J Title.

JAR directory contains all “xxxxx.jar” files for BD-J. A JAR (Java archive) file is a compressed file used in distributing a plurality of file collections. The JAR file is generally configured with a java classes file associated with a specific java program, auxiliary resources, metadata and the like. Various applications can be constructed by the JAR file.

AUXDATA directory includes files containing auxiliary information associated with disc playback. For instance, AUXDATA directory can include a sound file (“Sound.bdmv”) providing click sound and menu sound information and the like in playback and font files (“1111.otf”) providing font information in reproducing a text subtitle.

META directory is provided with metadata. The metadata is the data about a data. And, the metadata includes a search file, a file for Disc Library and the like for example.

Positions of the above explained files and directories are exemplary. And, it is apparent that the positions can be varied if necessary. For instance, BDJO directory and JAR directory as subdirectories can be separately configured below the root directory. For another instance, JAR directory can be configured as a higher directory below the root directory.

Moreover, the root directory can include a directory containing information about protection of data recorded within the recording medium or data downloaded to the local storage. This is represented as CERTIFICATE directory of the embodiment shown in FIG. 2. The root certificate file used for application authentication and binding unit authentication is placed in the CERTIFICATE directory.

FIG. 3 is a diagram of a data record structure recorded in a recording medium according to the present invention, in which a format of recording information associated with the aforesaid file structure within a disc is shown.

Referring to FIG. 3, in view from an inner area of a disc, there exist a file system information area as system information for managing an entire file, an area (“database area”) in which index file, object file, PlayList file, clip information file and metadata file are written to reproduce a recorded stream (*.m2ts) are recorded, and a stream or data area in which a stream configured with audio/video/graphic and the like or a JAR file is recorded.

An area for recording file information for reproducing contents within the data area and the like is named a management area. And, the file system information area and the database area correspond to the management area. Yet, each of the areas shown in FIG. 3 is exemplarily proposed. Hence, it is apparent that the present invention is not limited to the arranged structure of the respective areas shown in FIG. 3.

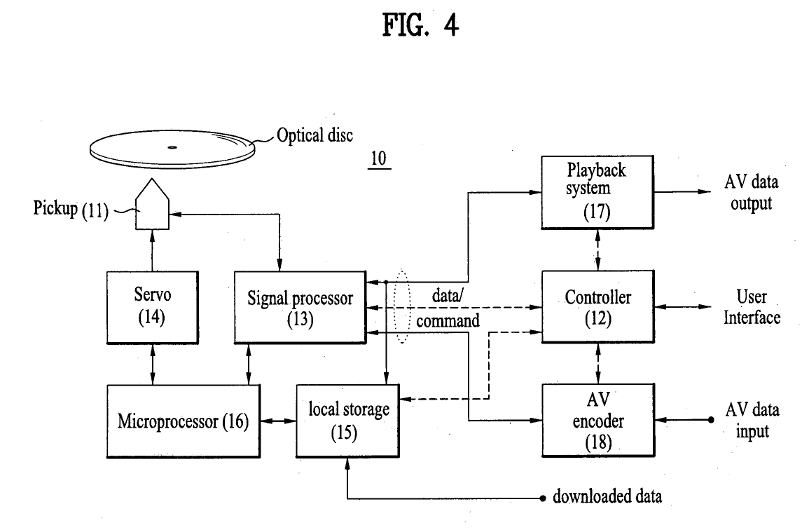

FIG. 4 is a block diagram of an optical recording/reproducing device according to one embodiment of the present invention.

Referring to FIG. 4, an optical recording/reproducing device according to one embodiment of the present invention basically includes a pickup 11 for reproducing management information including original data and reproduction management file information recorded in an optical disc, a servo 14 controlling an action of the pickup 11, a signal processor 13 restoring a reproduction signal received from the pickup 11 to a specific signal value, modulating a signal to be recorded into a signal recordable on the optical disc, and delivering the modulated signal, and a microprocessor 16 controlling the overall operations.

Additional data existing on a place except an optical disc is downloaded to local storage 15 by a controller 12. The controller 12 generates a binding unit using information recorded in a binding unit manifest file within the local storage 15. The controller 12 generates a virtual package to reproduce recording medium data and data within the local storage 15 using name mapping information recorded in the binding unit manifest file within the local storage 15. The controller 12 reproduces original data and/or additional data according to a user's request by utilizing the generated virtual package.

Besides, the virtual package is generated via a binding operation performed by a virtual file system and becomes a file structure for reproducing and managing an original clip configured with original data stored in a different area within a disc and an additional clip configured with additional data within the local storage 15.

The binding unit manifest file includes information used for a binding operation for generating the virtual package. Without the binding unit manifest file, the virtual package cannot be generated from binding the data within the local storage 15 with the file structure (disc package) within the recording medium.

The name mapping information, which is recorded in the binding unit manifest file, indicates where the data recorded within the recording medium is located in the virtual package.

The newly generated virtual package is stored in the local storage 15 for later reuse or can be temporarily stored in a separate dynamic memory to be utilized.

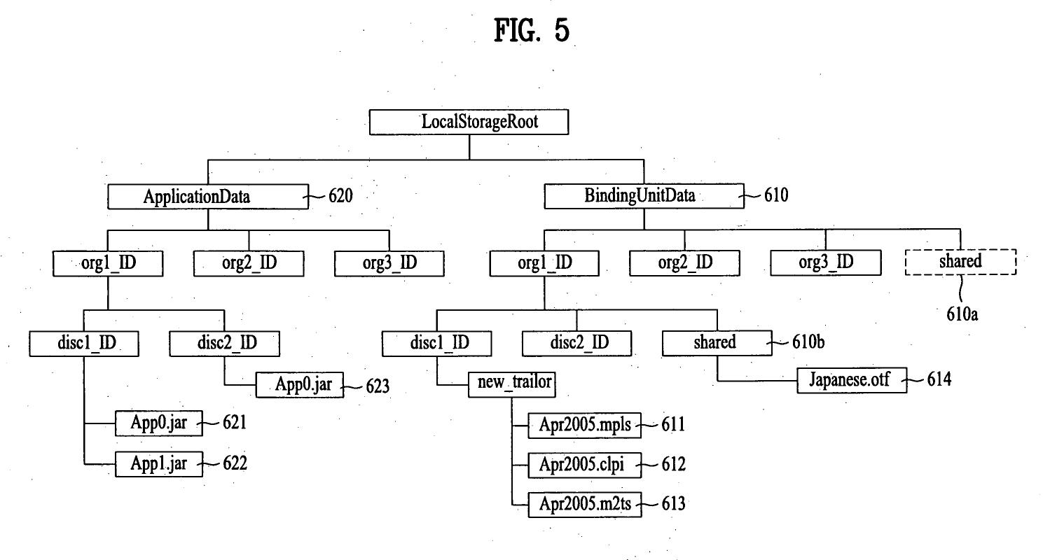

In the present invention, the controller 12 authenticates whether an application and contents are provided by an authentic content provider (CP) and then controls an access of the application to the contents. The authentication of the application will be explained in the description of FIG. 5 in detail.

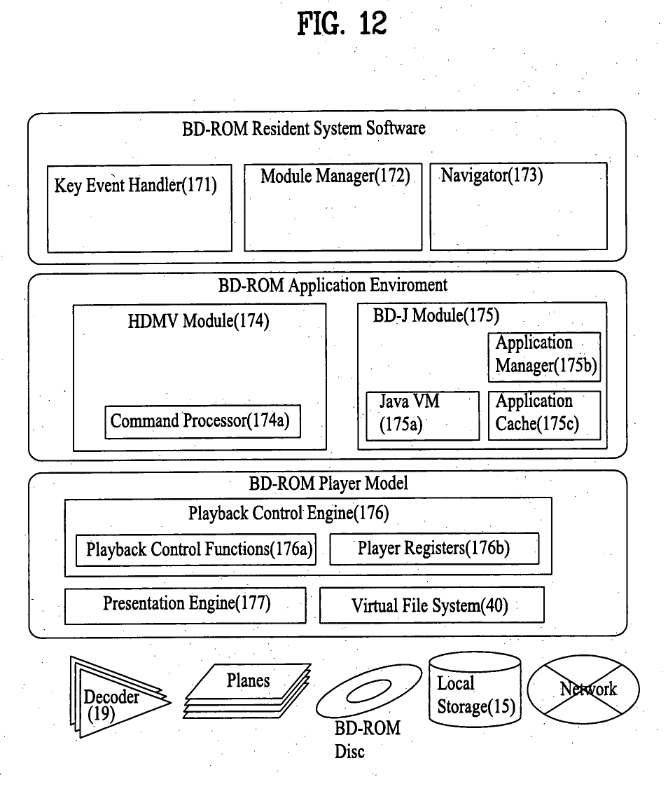

A playback system 17 finally decodes output data to provide to a user under the control of the controller 12. The playback system 17 includes a decoder decoding an AV signal and a player model deciding a reproduction direction by analyzing an object file command or application associated with the aforesaid reproduction of a specific title and a user command inputted via the controller 12. And, the playback system 17 will be explained in detail in the description of FIG. 12.

In order to record a signal in the optical disc, an AV encoder 18 converts an input signal to a signal of a specific format, e.g., an MPEG2 transport stream according to a control of the controller 12 and then provides the converted signal to the signal processor 13.

FIG. 5 is an exemplary diagram of file architecture within a local storage 15 according to the present invention.

Referring to FIG. 5, data, which is read out of a recording medium or is downloaded from a recording medium external source, can be stored in a local storage. A space storing the data can be divided into “Application Data Area (620)” used in storing application data and “binding Unit Area (610)” used for construction of a virtual package.

In an embodiment of FIG. 5, three organization-dependent directories org1_ID, org2_ID and org3_ID exist in the binding unit data area 610 within the local storage 15. An organization means each content provider (CP). For example, a film company or a film distributing company corresponds to the organization in case of a movie.

Besides, an organization-dependent shared directory can exist. And, data shared between content providers exists in the shared directory 610a.

The organization-dependent directory org1_ID includes disc-dependent directories disc1_ID and disc2_ID and a disc-dependent shared directory 610b as lower directories. In the disc-dependent shared directory 610b, data shared between recording mediums disc1_ID and disc2_ID provided by “org1_ID”.

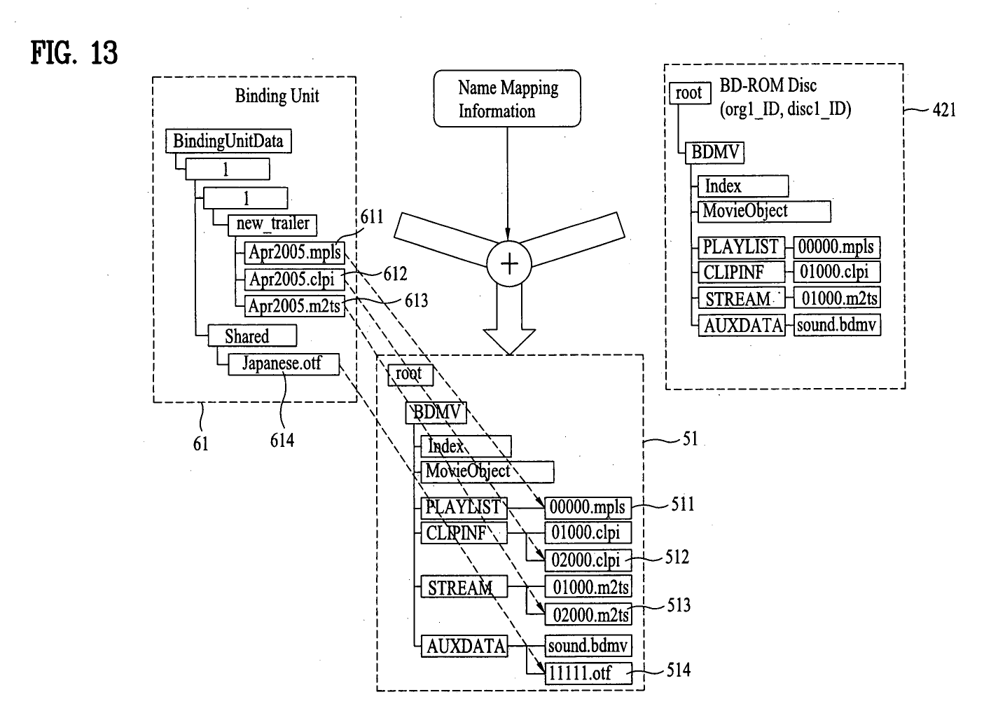

In the “disc1_ID”, a binding unit to be bound with “disc1” provided by “org1” exists. In the binding unit, a PlayList file “Apr2005.mpls (611)”, a clip information file “Apr2005.clpi (612)” and a stream file “Apr2005.m2ts (613)” exist. A method of constructing a virtual package by binding the files with data within a recording medium will be explained later with reference to FIG. 13.

In the application data area 620, three organization-dependent directories org1_ID, org2_ID and org3_ID exist. As lower directories of the “org1_ID”, directories disc1_ID and disc2_ID exist. The directory disc1_ID includes JAR files “APP0.jar (621)” and “App1.jar (622)” constructing specific applications, respectively. And, the disc-dependent directory disc2_ID includes a jar file “APP0.jar (623)”.

Besides, an application means a program for performing a specific function. And, the application should be capable of accessing all data, files, and hardware and software configurations of a playback system 17 to perform the function. For instance, in case that an application (hereinafter called App0) constructed by “App0.jar (621)” of the directory disc1_ID performs a specific function, if data “japanese.otf (614)” shared between recording mediums provided by the content provider org1_ID is needed to perform the function, the “App0” accesses the “japanese.otf”.

The present invention intends to provide a security scheme to protect data shared between recording mediums provided by a same content provider (CP) (e.g., data existing in the disc-dependent shared directory 610b: “japanese.otf (614)” in FIG. 5) or data shared between content providers (CPs) (e.g., data existing in the disc-dependent shared directory 610a).

Besides, three security scheme levels for protecting the shared data can be taken into consideration.

First of all, a first level is to authorize all applications to access all shared data. In this case, since any security mechanism is not needed, the first level is not discussed in the present invention.

The security scheme levels the present invention intends to provide are second and third levels. For the second level, it is assumed that authentication for the shared data is enough to protect the shared data. In case applications that use the shared data are authorized to access the shared data, respectively, it is assumed that operations of the application is reliable.

The third level is to protect the shared data by encrypting the shared data to provide to a user on the assumption that it is unable to exclude a malicious function of an application authorized to access the shared data. Besides, the application accessing the shared data needs to decrypt the shared data.

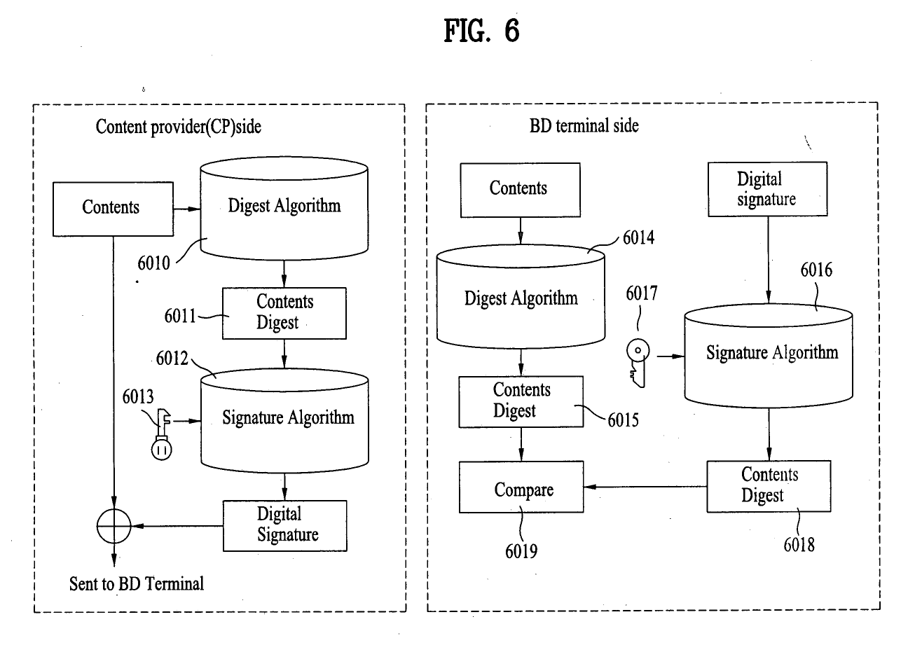

The second security level provided by the present invention is explained with reference to FIGS. 6 to 10. And, the third security level and a reproduction of the shared data having the third security level applied thereto will be explained with reference to FIG. 11.

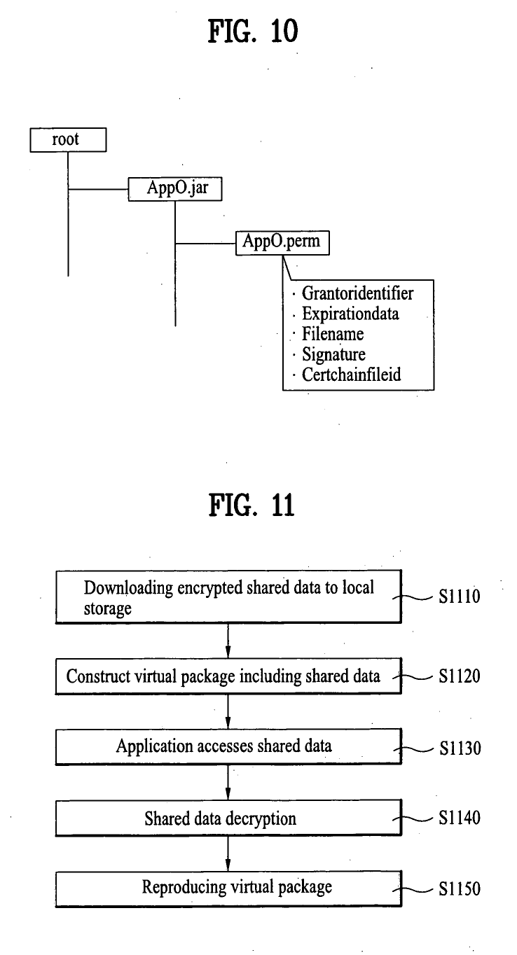

FIGS. 6 to 9 show authentication of shared data and application for the protection of the shared data according to the present invention. And, FIG. 10 shows a method of protecting the shared data by providing access information for the application that accesses the shared data.

FIG. 6 is a diagram of shared data authentication according to one embodiment of the present invention.

Referring to FIG. 6, in providing data, a content provider (CP) provides a certificate for the data to a user. The certificate can be provided to a user by being recorded within a recording medium or by being downloaded to the user from outside of the recording medium.

Besides, the certificate can include a version, a serial number, a signature algorithm, an issuer, an expiry date, an authentication subject, a public key, etc.

Besides, a public key means a key, which is opened to the public, of an asymmetric key pair, which is used for a public key cryptosystem, of one entity. And, the public key is used in deciding authenticity of a signature in a signature system to be called a verification key as well. A private key is a key, which is not opened to the public, of an asymmetric key pair, which is used for a public key cryptosystem, of one entity. In some cases, the private key may mean a key used in a symmetric key cryptosystem.

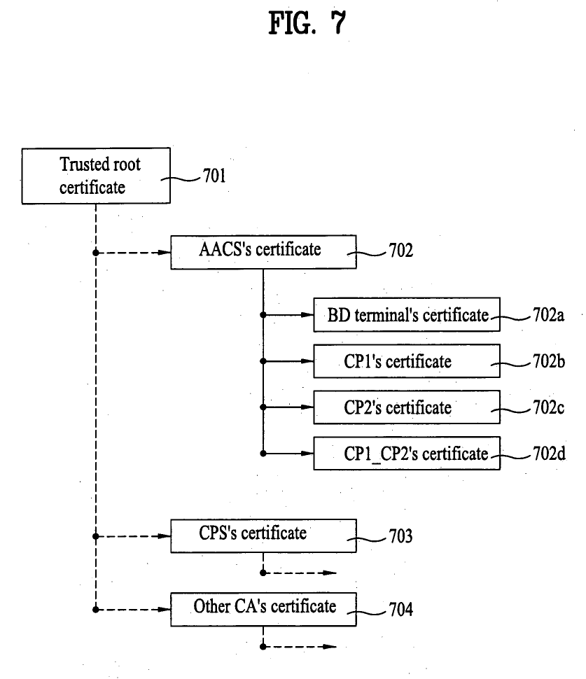

A certificate is used in certifying that data provided to a user is provided by a legitimate content provider. And, the certificate includes a digital signature of a certificate authority (CA) having issued the certificate. In the embodiment of FIG. 6, a content provider certifies himself for example. Hence, the certificate authority (CA) becomes a content provider (CP) himself. Certification of certificate will be explained in detail with reference to FIG. 7.

A content provider (CP) generates a contents digest 6011 to provide to a user using digest algorithm 6010 such as SHA-1 (secure hash algorithm-1), MD5 (message digest algorithm 5) and the like.

Besides, a contents digest means a simple character sequence rendered to be uniquely computed for each content. The contents digest is represented as a uniform-length bit sequence abbreviated by repeatedly applying a unidirectional hash function to contents having a random length. One contents digest is computed for each contents (message, sentence, file . . . ). And, the same contents cannot be computed from different documents. Hence, the contents digest is usable as a means for checking a forgery of an original text.

The generated contents digest 6011 becomes a digital signature via a signature algorithm 6012 using a CP's private key 6013. The content provider provides a certificate including the digital signature to a user together with contents.

Besides, a signature algorithm is a sort of an encryption algorithm such as RSA (Rivest-Shamir-Adelman), DSA (digital signature algorithm) and the like.

A digital signature can be restored to contents digest 6018 through a signature algorithm 6016 using a public key 6017 corresponding to a private key 6013 used for the digital signature. And, the pubic key 6017 is provided to a user by being included in the certificate. In case that the public key 6017 corresponding to the private key 6013 used for the generation of the digital signature does not exist, the digital signature cannot be restored to the contents digest 6018. In this case, it cannot be authenticated that a provided application is provided by a legitimate content provider.

Even if the digital signature is restored to the contents digest 6018 due to the existence of the public key 6017, in case that the provided contents are transmuted, the authentication fails. Namely, the content provided by the content provider is computed into a contents digest 6015 through a digest algorithm 6014. The computed contents digest 6015 is then compared to the contents digest 6018 restored using the digital signature (6019). If the contents are transmuted, the restored digest 6018 differs from the contents digest 6015 computed from the provided contents. Hence, the authentication of the contents comes into failure.

In case that the authentication of the shared data fails, it is preferable that a reproduction of the shared data should be restricted. Namely, in the present invention, the shared data can be downloaded to a local storage from outside of a reproduced recording medium. If a recording medium is loaded and if the shared data is associated with the loaded recording medium, the shared data is bound to a disc package within the recording medium. The binding operation is performed by a virtual file system of the aforesaid playback system 17. If the authentication of the shared data fails, the virtual file system may not bind the shared data to the disc package. Through this, the shared data, which is damaged in the course of download or is transmuted by hacking and the like, is prevented from being reproduced together with the recording medium. And, the shared data provided by an unauthorized content provider can be prevented from being reproduced. Hence, the content provider of the recording medium and the provider of the shared data can be protected.

FIG. 7 is a diagram of a certificate chain used for data authentication according to the present invention.

Multiple certificates can be enclosed with content, forming a hierarchical chain, wherein one certificate testifies to the authenticity of the previous certificate. At the end of a certificate hierarchy is a root CA, which is trusted without a certificate from any other CA. Certificates are stored in a key database, which is placed in a recording medium or BD terminal.

In particular, a trusted root certificate authority can certify certificate authorities (702, 703, 704). The certificate authority to be authenticated can be an AACS (advanced access content system) or a CPS (content protection system). In some cases, the AACS or CPS can become a root certificate authority by itself.

The AACS, CPS or other certificate authority can certify lower structures such as an optical recording/reproducing device, a content provider and the like independently (702a, 702b, 702c, 702d). Such a structure is called a certificate chain.

In the certificate chain, a higher certificate authority, which can certify the trusted certificate root authority (CA) does not exist. In this case, the trusted certificate authority certifies itself (701), which corresponds to a root certification.

Each of the certificate authorities provides a certificate including a digital signature of each of the certificate authorities for a result of certification of itself or its lower structures. A certificate provided by a lowest certificate authority of the certificate chain can be called a leaf certificate, and a certificate provided by a highest certificate authority of the certificate chain can be called a root certificate. The certificates can secure the integrity of the public key that restores the digital signature in the verification process of the digital signature.

Besides, a trusted root certificate provided by a trusted certificate authority is stored in a specific area of a recording medium in a file format or the like to be provided to a user or can be downloaded from outside of a recording medium to be stored in a key store of an optical recording/reproducing device.

The present invention intends to protect shared data through authentication of the shared data. Hence, in case that shared data is shared between recording media provided by a same content provider, e.g., a content provider 1 (CP1), a certificate 702b of the content provider 1 is used for authentication of the shared data.

In case that shared data is shared between recording media provided by a plurality of content providers, e.g., a content provider 1 (CP1) and a content provider 2 (CP2), a certificate 702d of both of the content providers 1 and 2 is used for authentication of the shared data.

A certificate generated through the certificate chain is stored in a specific area of a recording medium in a format of a file or the like to be used for authentication or can be used for authentication on a network.

In some cases, each of the certificate authorities can make a certificate revocation list (CRL). In this case, a content provider and user receives a downloaded the certificate revocation list, and then checks whether a certificate to be used for authentication is revoked before performing the authentication via the certificate. If the certificate to be authenticated is revoked, the authentication is not achieved. If the certificate is not revoked, the authentication is achieved on condition that other authentication requirements are met.

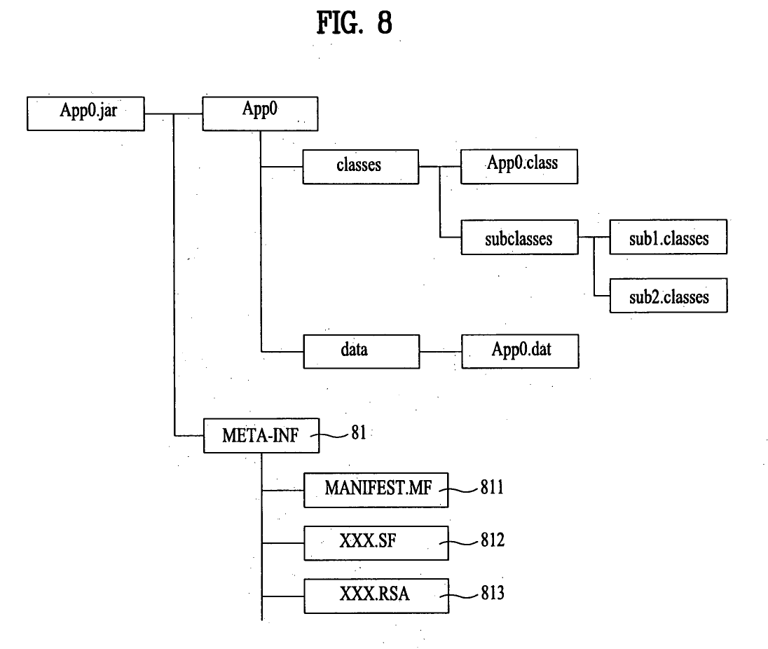

In the second security level provided by the present invention, in case that each application performing a specific function is authorized, it is assumed that an operation of the application is trusted. For this, an application having an authority of access to shared data is approved to access the shared data. To make the application's operation trusted, the corresponding application should be authenticated. This is explained in detail with reference to FIGS. 8 to 10 as follows.

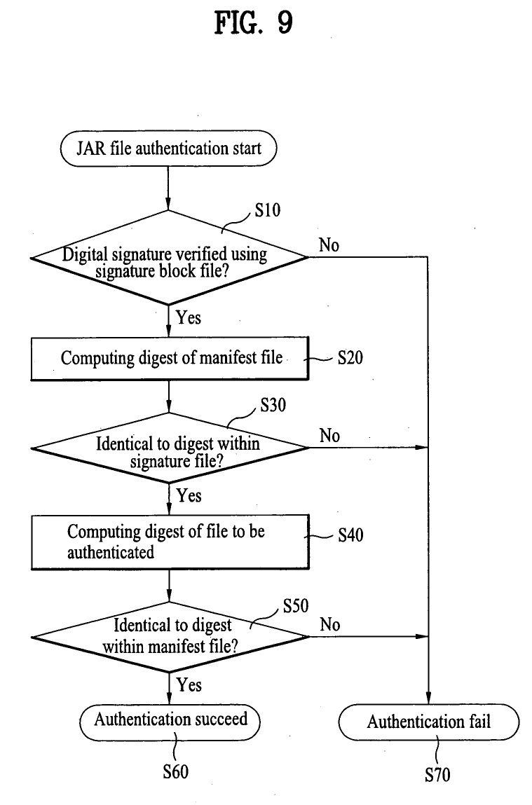

FIG. 8 and FIG. 9 show authentication of an application according to the present invention. And, FIG. 10 shows a JAR file configuring an application having access information to shared data according to the present invention. And, a signed application is taken as an example for FIG. 8 and FIG. 9.

FIG. 8 is a diagram of a JAR file configuring a signed application according to one embodiment of the present invention.

Referring to FIG. 6, a JAR file as a sort of a compressed file is used in collecting a plurality of files into one. If the JAR file is signed, the JAR file is called a signed JAR file. And, an application configured with the signed JAR file is called a signed application. The signed JAR file is equivalent to an original JAR file except that a manifest file is updated and that a signature file and a signature block file are added to METAINFO directory.

An application of FIG. 8 is a signed application. A JAR file configuring the application includes “APP0” file and METAINFO directory 81. “APP0” file includes “classes” file and a data directory. “APP0.dat” exists in the data directory. The “classes” file includes “APP0.class” file and “subclasses” directory. “sub1.class” and “sub2.class” exist in the “subclasses” directory. Besides, in the embodiment of FIG. 8, all class files (App1.class, sub1.class, sub2.class) are signed for example.

The METINFO directory 81 includes a manifest file (MANIFEST.MF) 811 and a signature book (XXX.RSA) 813. By the files, authentication of the application is achieved.

The manifest file 811 contains a listing of the files in a JAR file along with a message digest for each file signed. Besides, not all files in the JAR file need to be listed in the manifest file 811 as entries, but all files that are to be signed should be listed. Hence, entries for “APP0.class” file, “sub1.class” file and “sub2.class” file should be listed in the manifest file 811.

The signature file 812 contains the digest of the manifest file. The signature file will be the data signed by an authorizing organization.

After a message digest has been computed using contents of the signature file 812, a digital signature is generated by encrypting the computed result via signature algorithm using a private key. The digital signature can be a signed version of a signature file. The generated digital signature is placed within the signature block file 813. Each signature file may have multiple digital signatures, but those signatures should be generated by the same legal entity.

Besides, the private key is a private key corresponding to a public key existing in the signature block file 813. And, the public key is placed in one of leaf certificates of certificates within the signature block file 813. And, certificates authenticating the public key are included in the signature block file as well.

The signature block file 813 can be called a digital signature file. The digital signature file has the same file name of the signature file 812 but differs in extension. The extension is determined by signature algorithm. For instance, the extension corresponds to “.RSA”, “.DSA” or the like.

Authentication of an application accessing shared data is performed in a manner of authenticating files within a JAR file configuring the application. Authentication of files with a signed JAR file is explained in detail with reference to FIG. 9 as follows.

FIG. 9 is a flowchart of an authentication process of a file within a JAR file configuring a signed application according to one embodiment of the present invention, in which authentication of an application is carried out in a manner similar to that of the authentication of contents shown in FIG. 6.

Referring to FIG. 9, a signature over a signature file is firstly verified when a manifest is firstly parsed (S10). A digital signature exists in a signature block file. In particular, the signature block file corresponding to the signature file is located and certificates are read out of the signature block file. And, a public key corresponding to a private key used for the generation of the signature file exists within a leaf certificate among the certificates. An encrypted digital signature existing within the signature block file is restored to digest using the public key. The restored digest is then compared to digest of the signature file. If the compared digests are identical to each other, a verification of the digital signature is executed. If the verification of the digital signature fails, an authentication of the file fails (S70).

To check a validity of a file to be authenticated, digest for a manifest file is computed (S20). The computed digest value is then compared to a value of the digest existing within the signature file (S30). If the two compared digest values are different from each other, the authentication of the file fails (S70). If the two compared digest values are equal to each other, integrity for the manifest file is confirmed.

If the compared digest values are equal to each other, digest value for actual data of the file to be authenticated is computed (S40). The computed digest value is compared to the digest value within the manifest file (S50). If the compared digest values are equal to each other, the validity of the file is confirmed so that the file succeeds in the authentication (S60). Yet, if the compared digest values are different from each other, the file fails in the authentication (S70).

In authenticating a file within a JAR file configuring an application, the present invention is characterized in that integrity of a manifest file is checked using a signature file and in that a digital signature is verified using a signature block file. And, the present invention is characterized in that integrity for actual data of a JAR file is checked using the manifest file.

Hence, the integrity check for the actual data of the JAR file (S40, S50), the integrity check of the manifest file (S20, S30) and the verification of the digital signature (S10) can be individually implemented. Namely, the above-explained sequence of authentication flow of the embodiment shown in FIG. 9 is not mandatory but can be changed according to a playback system.

Besides, in authenticating the application, it is able to confirm whether the file to be authenticated is listed on the manifest file before the digest for the actual data of the file to be authenticated is computed (S40).

Moreover, the verification result (S10) of the digital signature and the result (S30) of the integrity check for the manifest file can be stored for a later use. In this case, the steps S10 to S30 will be executed once in an authentication process of one JAR file.

Although the authentication of the application fails, an access to the shared data can be approved according to an implementation of a player. Yet, it is preferable that the access should be restricted for the protection of the shared data. The extent of the access restriction can be set in a manner that an authenticated application is restricted to access all shared data according to the implementation of the player. Alternatively, a player can be controlled to access a limited range of the shared.

FIG. 10 is a diagram of a JAR file configuring an application according to one embodiment of the present invention.

Referring to FIG. 10, the present invention employs access information about the shared data for an application using the shared data as a resource. As an application having valid access information is enabled to access shared data, the shared data is prevented from being used by an unauthorized application.

The access information may be credentials for the application. The credentials can be included in a permission request file. And, the permission request file can exist within a JAR file configuring the application.

A JAR file APP0.jar shown in FIG. 10 is a file configuring an application. In the JAR file, a permission request file App0.perm including credentials exists. As credentials, there exists “grantor identifier”, “expiration date”, “filename”, “signature”, “certchainfileid” or the like.

The “grantor identifier” is the information about a subject that provides an application. As a grantor identifier, there is “org1_ID” or the like for example.

The “expiration date” means an expiry period of the credential. For instance, if the expiration date is given as “23/02/2035”, an application containing the credential is unable to access shared data after Feb. 23, 2035.

The “filename” is information about a location of shared data and a read/write right granted for the shared data. For instance, “filename read” information is given as “true”, and “filename” can be given as “BUDA/org1_ID/Shared/Japanese.otf” to represent a location of a file. This is explained with reference to FIG. 6 as follows. It means that an application having the credential can read the “japanese.otf (614)” file by accessing the “japanese.otf (614)” file existing within the “shared” directory of the binding unit data area within the local storage.

The “signature” contains a signature from the grantor.

And, the “certchainfileid” is used for locating a specific certificate within the Signature Block file. The “certchainfileid” should specify serialNumber that matches the serial number of the leaf certificate used for authentication and issuer that matches the subject of the leaf certificate used for authentication. The certificate that leads to the public key of the signature should be placed in the “certificates” field of the Signature Block file. Each certificate should be checked until one is found with the serial number and the organisation ID of the issuer field matching the content of the certchainfileid field of the credential. If a matching certificate could be found within the Signature Block file, the file access shall not be granted.

If the credential for the application is authenticated and includes valid “filename” for the shared data, the application can access the shared data. On the other hand, if the credential is not valid, the application is not trusted so that limitation is put on the shared data access of the application. Therefore, the present invention can protect the shared data by placing the credential in the application to access the shared data.

Besides, during the construction of virtual package, there is a case where the JAR file on the local storage overrides the corresponding JAR file on the disc. In such a case, even if the JAR file on the disc contains credential, the credential of the local storage should be used.

When a permission request file is present within a JAR file, the permission request file should be authenticated.

FIG. 11 is a flowchart of shared data reproducing method according to one embodiment of the present invention.

First of all, it is assumed that another security level provided by the present invention cannot exclude a malicious function of an application permitted to access shared data (authorized application). Hence, the present invention is characterized in that shared data is encrypted to be provided to a user for the protection of the shared data. Applications to access the shared data should be capable of decrypting the shared data.

In case that shared data is encrypted to be provided, even if an application can access the shared data, the shared data should be decrypted to enable the application to perform a specific function using the shared data.

A method of reproducing shared data, which is encrypted and protected according to the present invention, is explained with reference to FIG. 11 as follows.

Referring to FIG. 11, shared data, which is associated with a recording medium and is encrypted, is downloaded to a local storage from outside of the recording medium (S1110). And, an application having the shared data downloaded needs to be an application that can access the shared data via network.

Once the recording medium is loaded, if the shared data associated with the recording medium exists in the local storage, data recorded within the recording medium and the shared data are bound together by a binding operation to construct a virtual package (S1120).

Besides, in case that a virtual package already exists prior to downloading the shared data, the virtual package shall be updated as well as the downloaded shared data.

Preferably, the shared data is authenticated prior to the construction of the virtual package. In case of the authentication of the shared data fails, a virtual file system will construct a virtual package using a disc package within the loaded recording medium. In this case, by cutting of a construction of a virtual package including incorrect shared data, it is able to protect an authentic content provider.

The data within the local storage and the data recorded within the recording medium are reproduced together using the virtual package. To perform the reproduction, an application to perform the reproduction accesses the shared data bound to the data within the recording medium (S1130).

In case that the shared data is encrypted, since the shared data needs to be restored to a form that is reproducible by a decoder, the encrypted shared data has to be decrypted. Hence, it is preferable that an application accessing the encrypted shared data includes information enabling decryption of the shared data. The information may enable an application accessing the shared data to decrypt the shared data in direct. And, the information may execute an application enabling decryption of the shared data.

In case that an application accessing the shared data has valid information enabling decryption of the shared data, the shared data is decrypted using the information (S1140). Once the shared data is decrypted, the decrypted shared data is provided to a decoder to be reproduced together with other files within the virtual package (S1150).

Besides, other data existing within the local storage together with the shared data can be reproduced by being bound to the data within the recording medium. If other data reproduced together with the shared data are encrypted, they can be reproduced after completion of decryption.

If the shared data is encrypted according to the present invention, even if an erroneous application accesses the shared data, it is unable to perform a specific function using the shared data. Hence, it is advantageous that the shared data can be protected against a malicious function.

For the present invention, various encryption/decryption systems for shared data are possible. In aspect of a key generation for encryption/decryption of the shared data, a unique key of a content provider can be used for the data shared between recording media provided by the same content provider.

In case that shared data is encrypted, encryption/decryption key pairs or secret information to generate keys need to be distributed to a user to enable the shared data to be decrypted. The key pairs or secret information to generate keys can be stored in a recording medium to be provided to a user. This works on the assumption that data in a local storage should be accesses when a disc with key is in BD terminal. The key pairs or the secret information to generate keys can be enclosed in an application, which uses the shared data, to be provided to a user. In some cases, the key pairs or the secret information to generate keys can be stored at keystore of an optical recording/reproducing device.

If a player has to perform a specific function using an encrypted shared data, the player reads a key enabling decryption of the encrypted shared data from a recording medium, application, keystore or the like (in case of secret information to generate keys, a key is generated by reading out the secret information to generate keys) and then decrypts the shared data.

In data encryption systems, there are symmetric cryptographic methods and asymmetric cryptographic methods. As a representative symmetric cryptographic method, there is AES (advanced encryption standard), DES (data encryption standard), IDEA (international data encryption algorithm) or the like. As a representative asymmetric cryptographic method, there is RSA (Rivest-Shamir-Adelman), DSA (digital signature algorithm) or the like.

In the security scheme for protecting shared data by encrypting the shared data according to the present invention, the application accessing the encrypted shared data may be an application including access information about the shared data. The access information may be credential of the application. In some cases, an application without credential may be permitted to access the encrypted shared data.

It may happen that a player fails in authenticating an application accessing the encrypted shared data. In this case, whether to permit the shared data access of the application depends on an implementation of the player. Namely, even if the authentication fails, the application can be made to access the shared data. By the present invention, if shared data is encrypted to be provided, the shared data can be protected despite that an authenticated application attempts to access the shared data.

Besides, the signed application is taken as an example for the description of FIG. 8 and FIG. 9. Yet, an unsigned application exists as well. In case of the unsigned application, it is unable to verify its validity. Hence, it is preferable that the unsigned application is not permitted to access the shared data.

FIG. 12 is a block diagram of a recording medium playback apparatus utilizing playback system according to one embodiment of the present invention.

First of all, “playback system” includes a collective reproduction processing means constructed with a program (software) and/or hardware provided within the optical recording/reproducing device. The playback system plays a recording medium loaded in the optical recording/reproducing device and simultaneously reproduces and manages the data that is associated with the recording medium and is stored in the local storage (e.g., data downloaded from outside).

Specifically, playback system 17 includes “Key Event Handler(171)”, “Module Manager(172)”, “HDMV Module(174)”, “BD-J Module(175)”, “Playback control engine(176)”, “Presentation engine(177)” and “Virtual File System(40)”, which are explained in detail as follows.

First of all, as separate reproduction processing management means for reproducing HDMV Title and BD-J Title, respectively, “HDMV Module (174)” for HDMV Title and “BD-J Module (175)” for BD-J Title are independently configured. Each of the “HDMV Module (174)” and the “BD-J Module (175)” has a control function of receiving to process a command or program within the aforesaid object file (Movie Object or BD-J Object). Each of the “HDMV Module (174)” and the “BD-J Module (175)” separates a command or application from the hardware configuration of the playback system to enable a portability of the command or application.

As a means for receiving to process the command or application, “Command processor (174a) is provided within the “HDMV Module (174) or “Java VM (175a)”, “Application manager (175b)” and “Application Cache (173c)” are provided with the “BD-J Module (175).

“Java VM(175a)” is “Virtual Machine” that executes an application. “Application manager (175b)” includes a application management function of managing a life cycle of an application. “Application manager (175b)” can load applications from Application Cache (173c). The purpose of the Application Cache (173c) is to guarantee seamless playback of AV data from the disc during application loading and to reduce latency in loading data. Namely, the Application Cache(173c) is the preload buffer for BD-J. Yet, a player can use additional data, including class files, which is not preloaded. One example of this is the loading of data from JAR files in a local storage.

Moreover, “Module Manager (172)” is provided to deliver a user command to the “HDMV Module (174)” or the “BD-J Module (175)” and to control an operation of the “HDMV Module (174)” or the “BD-J Module (175)”. And, “Playback control Engine (176)”, which interprets PlayList file information recorded within a disc according to a reproduction command of the “HDMV Module (174)” or the “BD-J Module (175)” and performs a corresponding reproduction function, is provided. Moreover, “Presentation Engine (177)” for decoding a specific stream reproduced and managed by the “Playback Control Engine (176)” and displaying the decoded stream on a screen is provided.

Specifically, the “Playback Control Engine (176)” includes “Playback Control functions (176a)” actually managing all reproductions and “Player Registers (176b)” storing player status registers (PSR) and general purpose register (GPR). In some cases, “Playback Control functions (176a)” may mean “Playback Control Engine (176)”.

In the above-explained playback system of the present invention, the “Module Manager (172)”, “HDMV Module (174)”, “BD-J Module (175)” and “Playback Control Engine (176)” enable software processings, respectively. Substantially, software processing is more advantageous than a hardware configuration in design. Yet, the “Presentation Engine (177)”, decoder and plane are normally designed by hardware. In particular, the elements (e.g., reference numbers 172, 174, 175, 176) processed by software can be configured with a portion of the controller 12. Hence, the configuration of the present invention should be understood by its meaning but is not limited to a hardware configuration or a software configuration.

The playback system 17 according to the present invention has the following features.

First of all, “HDMV Module (174)” for HDMV Title and “BD-J Module (175)” for BD-J Title are independently configured. And, both of the modules 174 and 175 are not simultaneously executed. Namely, BD-J Title cannot be played back while HDMV Title is being played back, and vice versa.

Secondly, applications, which are programs of managing a network function within an optical recording/reproducing device like the operation of downloading additional data from outside and a local storage 15 like an operation of constructing a virtual package by editing files stored in the local storage 15 or by binding the files to a disc package, are provided within the playback system 17. Namely, the applications configure a virtual file system 40 managing a file system within a disc and a local storage file system as one system and construct and manage a virtual package for reproducing original data and additional data via the configured virtual file system 40.

Thirdly, HDMV Title and BD-J Title receive user commands of separate types, respectively and execute user commands independent from each other, respectively. “Key Event Handler (171)” receives a user command to deliver to one of “HDMV Module (174)”, “BD-J Module (175)” and “Module Manager (172)/Navigator (171)”. For instance, if a received command is a user command by “User Operation (UO)”, “Key Event Handler (171)” performs the command in a manner of transferring it to “Module Manager (172)”. If a received command is a user command by “Key Event”, “Key Event Handler (171)” performs the command in a manner of transferring it to “BD-J Module (175)”.

Fourthly, a management, which can be called “master”, of the aforesaid “Playback control Engine (176)” is taken charge of by one of the currently operating modules 174 and 175. Namely, “HDMV Module (174)” becomes a master while HDMV title is being reproduced. “BD-J Module (175)” becomes a master while BD-J title is being reproduced.

Besides, “Navigator (173)” is made to perform a title selection under the control of a user at anytime and can provide a recording medium and title metadata to a user.

FIG. 13 is an exemplary diagram for explaining shared data protection according to the present invention, in which a virtual package is shown in detail.

First of all, a specific file structure (e.g., the structure shown in FIG. 2) is recorded within a loaded disc, which is called a disc package in particular. A local storage system exists within a local storage. And, a binding unit and binding unit manifest file bound to the loaded disc (e.g., disc1_ID) are included in the corresponding file system.

Besides, the binding unit manifest file contains name mapping information. And, the name mapping information is the information about the binding unit. For instance, the name mapping information includes information about locations, file names and the like within a virtual package in case of binding a list of files generating the binding unit to a disc.

Hence, the virtual file system 40 constructs a new virtual package through a binding operation of binding the binding unit to the disc package within the loaded disc by utilizing the name mapping information. And, the virtual file system 40 plays a role in controlling an access mechanism to a file belonging to the virtual package.

The virtual package constructed by the virtual file system can be used for both BD-J and HDMV modes. In the BD-J mode, applications located on a recording medium or a local storage can access the virtual package via the virtual file system. In the HDMV mode, MovieObject can access the virtual package.

Referring to FIG. 13, in a recording medium file structure (disc package) 421 within a disc, a BD directory (BDMV) as a lower directory of a root directory (root) includes an index file (Index.bdmv), an object file (MovieObject.bdmv), a PlayList file (00000.mpls), a clip information file (01000.clpi), a stream file (01000.m2ts) and an auxiliary data file (sound.bdmv).

A binding unit 61 associated with a loaded disc (e.g., disc of “org1_ID” and “disc2_ID”) includes a specific PlayList file (Apr2005.mpls) 611, a clip information file (Apr2005.clpi) 612, i.e., a clip managed by the PlayList file, and a stream file (Apr2005.m2ts) 613.

In case that a auxiliary data file (japanese.otf) 614 as shared data provided by a content provider exists in a disc-dependent shared directory (Shared), a method of constructing a virtual package 51 is explained as follows.

According to name mapping information, the PlayList file (Apr2005.mpls) 611, clip information file (Apr2005.clpi) 612, stream file (Apr2005.m2ts) 613 and auxiliary data file (japanese.otf) 614 within the binding unit are changed in file name into a PlayList file (00000.mpls) 511 of a PlayList directory, a clip information file (02000.clpi) 512 of a CLIPINF directory, a stream file (02000.m2ts) 513 of a STREAM directory, and an auxiliary data file (11111.otf) of an AUXDATA directory in a virtual package 51, respectively.

The virtual package 51 includes an index file (Index) according to the virtual package and a MovieObject file in BDMV directory as a lower directory of a root directory. PlayList file (00000.mpls) 511 replaced by the PlayList file of the binding unit is placed in PLAYLIST directory. In CLIPINF directory, the clip information file (02000.clpi) 512 of the binding unit is appended to the clip information file (01000.clpi) of a recording medium. In STREAM directory, the stream file (02000.m2ts) 513 of the binding unit is appended to a stream file (01000.m2ts) of a recording medium. In AUXDATA directory, the auxiliary data file (11111.otf) 514 of the binding unit is appended to an auxiliary data file (sound.bdmv) of a recording medium.

Besides, the index file (Index) and the MovieObject file as upper files within the virtual package can be updated via an index table and a MovieObject file within a previous disc based on a newly generated PlayList file (00000.mpls) 511. In particular, the index file and the MovieObject file are updated in case that a title is changed by the PlayList file (00000.mpls) 511 within the virtual package. In this case, the title change means a new title addition, a previous title deletion, scenario change of title playback or the like.

In case of the security level for protecting shared data through authentication of the shared data among the security levels provided by the present invention, if the authentication of the shared data fails, the virtual file system preferably does not construct the virtual package 51 including the shared data. Yet, a virtual package is constructed using a disc package within a recording medium. In this case, a player is unable to reproduce “11111.otf” that is shared data stored within a local storage. Hence, by preventing shared data of an unauthorized provider from being reproduced together with a recording medium, an authentic content provider can be protected.

Even if a virtual package including the shared data is constructed due to successful authentication of the shared data, if credential of the application to access the shared data is not valid, the application is unable to access the shared data. Hence, by preventing the shared data from being reproduced and by preventing playback conducted by an invalid application, the shared data can be protected.

According to another security level provided by the present invention, shared data cannot be reproduced by an application in capable of decrypting encrypted data. Hence, if the shared data “11111.otf (514)” within the virtual package is an encrypted file, the file can be reproduced by an application enabling decryption of the encrypted file. If an application is provided by an unauthorized grantor, the application would not have information of enabling the decryption of the shared data. Hence, even if the unauthorized application is capable of accessing the shared data, the shared data cannot be decrypted. Hence, the shared data can be protected.

A recording medium according to the present invention is explained with reference to FIG. 4 as follows.

An apparatus for reproducing a recording medium using a local storage according to the present invention includes a local storage 15 storing downloaded shared data associated with the recording medium and a controller 12 controlling an application having valid access information for the shared data to access the shared data. The access information can include credential of the application. And, the credential can be included in a permission request file.

Besides, the permission request file can exist within a JAR file configuring the application. In this case, the permission request file is preferably authenticated.

The controller 12 can protect the shared data by authenticating the shared data before the application accesses the shared data.

In case that the shared data is the data shared between recording media provided by a content provider, the shared data can be authenticated using a certificate of the content provider. If the shared data is shared between a plurality of content providers, the shared data can be authenticated using certificates of the content providers.

An apparatus for reproducing a recording medium using a local storage according to the present invention includes a local storage 15 storing an downloaded encrypted shared data associated with the recording medium, and a controller 12 constructing a virtual package including the shared data by binding data within the local storage to data within the recording medium.

The controller 12 reproduces the shared data together with other data within the local storage 15 and/or the data within the recording medium using the virtual package. In doing so, as the shared data is encrypted to be provided, the controller 12 reproduces the shared data after decryption.

In decrypting the shared data, the controller 12 enables an application having valid access information to the shared data to access the shared data. The access information is credential of an application to access the shared data. The access information can exist in a permission request file. And, the permission request file can be included in a JAR file configuring the application.

In constructing the virtual package, it is preferable that the controller 12 authenticates the shared data and then constructs the virtual package. In case that the shared data is the data shared between recording media provided by a content provider, the shared data can be authenticated using a signature within a certificate of the content provider. If the shared data is the data shared between a plurality of content providers, the shared data can be authenticated using a common signature within each certificate of the content providers.

In case that the shared data is the data shared between recording media provided by a content provider, the shared data is encrypted using a key for the content provider and is then provided to a user. If the shared data is the data shared between a plurality of content providers, the shared data is encrypted using a key in accordance with the content providers and is then provided to a user.

The encrypted shared data can be reproduced after having been decrypted. In the decryption, a key included in an application to access the shared data can be used. And, a key stored in a recording medium is usable as well. In some cases, a key stored in an optical recording/reproducing device is usable for the decryption.

Hence, by the present invention, the contents provided by an authentic content provider and the non-transmuted contents can be reproduced, whereby the shared data can be protected.

Accordingly, the present invention provides the following effects and/or advantages.

First of all, by authenticating the shared data, the contents provided by an authentic content provider and the non-transmuted contents can be reproduced, whereby the shared data can be protected.

Secondly, by providing the shared data access information to an application, the shared data can be protected against a malicious function caused by an unauthorized application.

Thirdly, by encrypting the shared data, the shared data can be prevented from being used by an unauthorized application.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of protecting shared data, comprising the steps of:
downloading the shared data associated with a recording medium to a local storage; and
permitting an application having valid access information for the shared data to access the shared data.

2. The method of claim 1, wherein the access information is credential of the application.

3. The method of claim 2, wherein the credential is included in a permission request file.

4. The method of claim 3, wherein the permission request file exists within a JAR file configuring the application.

5. The method of claim 2, wherein the credential includes Grantoridentifier, Expirationdate, Filename, Signature and Certchainfileid.

6. The method of claim 1, further comprising the step of authenticating the shared data before the application accesses the shared data.

7. The method of claim 6, wherein if the shared data is shared between recording media provided by a content provider, the shared data is authenticated using a certificate of the content provider.

8. The method of claim 7, wherein the certificate includes a signature of the content provider.

9. The method of claim 6, wherein if the shared data is shared between a plurality of content providers, the shared data is authenticated using a certificate of a plurality of the content providers.

10. The method of claim 9, wherein the certificate includes a common signature of a plurality of the content providers.

11. A method of reproducing a recording medium using a local storage, comprising the step of:
downloading encrypted shared data associated with the recording medium to the local storage;
constructing a virtual package including the shared data by binding data within the local storage to data within the recording medium;
decrypting the shared data using the virtual package; and
reproducing the decrypted shared data.

12. The method of claim 11, wherein the shared data is reproduced by execution of application accessing the shared data.

13. The method of claim 12, wherein the application includes credential of the application as access information to the shared data.

14. The method of claim 12, wherein the shared data is decrypted using a key included in the application.

15. The method of claim 11, wherein the shared data is decrypted using a key stored in the recording medium.

16. The method of claim 11, wherein the shared data is decrypted using a key stored in an optical player.

17. The method of claim 11, wherein in constructing the virtual package, the shared data is authenticated to construct the virtual package.

18. The method of claim 17, wherein if the shared data is shared between recording media provided by a content provider, the shared data is authenticated using a signature within a certificate of the content provider.

19. The method of claim 17, wherein if the shared data is shared between a plurality of content providers, the shared data is authenticated using a common signature within a certificate of a plurality of the content providers.

20. The method of claim 11, wherein if the shared data is shared between recording media provided by a content provider, the shared data is authenticated using a key for the content provider.

21. The method of claim 11, wherein if the shared data is shared between a plurality of content providers, the shared data is authenticated using a key in accordance with a plurality of the content providers.

22. An apparatus for protecting shared data, comprising:
a local storage storing downloaded shared data associated with a recording medium; and
a controller controlling an application having valid access information for the shared data to access the shared data.

23. The apparatus of claim 22, wherein the access information is credential of the application.

24. The apparatus of claim 23, wherein the credential is included in a permission request file.

25. The apparatus of claim 24, wherein the permission request file exists within a JAR file configuring the application.

26. The apparatus of claim 22, wherein the controller authenticates the shared data before the application accesses the shared data.

27. The apparatus of claim 26, wherein if the shared data is shared between recording media provided by a content provider, the shared data is authenticated using a certificate of the content provider.

28. The apparatus of claim 26, wherein if the shared data is shared between a plurality of content providers, the shared data is authenticated using a certificate of a plurality of the content providers.

29. An apparatus for reproducing a recording medium using a local storage, comprising:
a local storage storing downloaded encrypted shared data associated with the recording medium; and
a controller constructing a virtual package including the shared data by binding data within the local storage to data within the recording medium, the controller decrypting to reproduce the shared data using the virtual package.

30. The apparatus of claim 29, wherein in decrypting the shared data, the controller controls an application having valid access information for the shared data to access the shared data.

31. The apparatus of claim 30, wherein the access information is credential of the application accessing the shared data.

32. The apparatus of claim 30, in constructing the virtual package, the controller authenticates the shared data to construct the virtual package.

33. The apparatus of claim 32, wherein if the shared data is shared between recording media provided by a content provider, the controller authenticates the shared data using a certificate of the content provider,
wherein the certificate includes a signature of the content provider.

34. The apparatus of claim 32, wherein if the shared data is shared between a plurality of content providers, the controller authenticates the shared data using a certificate of a plurality of the content providers,
wherein the certificate includes a common signature of a plurality of the content providers.

35. The apparatus of claim 29, wherein if the shared data is shared between recording media provided by a content provider, the shared data is encrypted using a key for the content provider.

36. The apparatus of claim 29, wherein if the shared data is shared between a plurality of content providers, the shared data is encrypted using a key in accordance with a plurality of the content providers.

37. The apparatus of claim 29, wherein in decrypting the shared data, the controller decrypts the shared data using a key included in an application to access the shared data.

38. The apparatus of claim 29, wherein in decrypting the shared data, the controller decrypts the shared data using a key stored in the recording medium.

39. The apparatus of claim 29, wherein in decrypting the shared data, the controller decrypts the shared data using a key stored in an optical recording/reproducing device.
